(19) United States
(12) Patent Application Publication
(10) Pub. No.: US 2008/0191639 A1
(43) Pub. Date: Aug. 14, 2008

(54) Flat panel display having a backlight module

(75) Inventors: Shih-Ming Chen, Tainan City (TW); Yong-Long Lee, Tainan City (TW)

Correspondence Address: FISH & RICHARDSON PC, P.O. BOX 1022, MINNEAPOLIS, MN, 55440-1022, US

(73) Assignee: Chi Mei Optoelectronics Corp., Tainan County (TW)

(21) Appl. No.: 11/599,185

(22) Filed: Nov. 14, 2006

(30) Foreign Application Priority Data
Nov. 15, 2005 (TW) 94140161

(51) Int. Cl. H05B 41/16; H04N 3/14

(52) U.S. Cl. 315/287; 348/790; 348/E03.016

(57) ABSTRACT

A backlight module that includes a lamp and a single side driving inverter that is coupled to one end of the lamp. The single side driving inverter is configured to control an operating current of the lamp to be within 80% to 100% of a saturation luminance current. The lamp has a characteristic such that when the operating current is lower than the saturation luminance current, the lamp luminance increases as the operating current increases, and when the operating current is substantially equal to or higher than the saturation luminance current, the lamp luminance does not increase as the operating current increases.

### CROSS-REFERENCE TO RELATED APPLICATIONS

This application claims priority to Taiwan application serial no. 94140161, filed Nov. 15, 2005, the contents of which are incorporated by reference.

### BACKGROUND OF THE INVENTION

The description relates to flat panel displays that have backlight modules.

An example of a flat panel display is a liquid crystal display. In a transmissive or transflective type liquid crystal display, a backlight module generates light that is modulated by a liquid crystal layer to form an image. The backlight module can include lamps, e.g., cold cathode fluorescent lamps (CCFLs), and drivers for driving the lamps using single-side driving or double-side driving. When single-side driving is used, a single-side-driving inverter converts a DC voltage to an AC voltage having a high root-mean-square (rms) value (e.g., over 100V) and a high frequency (e.g., over 1000 Hz) that is applied to one end of each lamp, with the other end of the lamp connected to ground. When double-side driving is used, AC driving voltages having opposite phases are applied to the two ends of each lamp.

CCFLs are designed to operate at a rated current within a particular range, e.g., 4 mA to 6 mA. When the operating lamp current is near the rated current, the luminance of the lamp increases as the lamp current increases. When the lamp current increases further to a level referred to as the “saturation luminance current level (abbreviated as saturation current level),” e.g., around 13 to 15 mA, the luminance of the lamp “saturates” and does not increase further when the lamp current increases.

Parasitic capacitances may exist between the lamps and nearby conducting materials, such as the display housing, a reflective foil, or metal wires. Due to the large voltage difference between the two ends of the lamps, leakage current may flow through the parasitic capacitors to system ground. For lamps that are used in large size flat panel displays (e.g., having a diagonal size of 37 inches and above), the leakage current may be sufficiently large to causes the luminance to vary from one end of the lamp to the other end, causing non-uniformity in display luminance.

### SUMMARY

In one aspect, in general, a backlight module, includes a lamp, and a single side driving inverter that is coupled to one end of the lamp and configured to control an operating current of the lamp to be within 80% to 100% of a saturation luminance current. The lamp has a characteristic such that when the operating current is lower than the saturation luminance current, the lamp luminance increases as the operating current increases, and when the operating current is substantially equal to the saturation luminance current, the lamp luminance does not increase as the operating current increases.

Implementations of the backlight module can include one or more of the following features. The lamp can be cold cathode fluorescent lamp. The single side driving inverter can be configured to adjust a duty cycle of the operating current to reduce the luminance of the lamp. The backlight module can include additional lamps, the single side driving inverter configured to control operating currents of each of the additional lamps to be within 80% to 100% of the saturation luminance current. In some examples, the single side driving inverter can be configured to alternate the operating currents between a higher level and a lower level such that the lamps alternate between a brighter state and a darker state for a user-selectable maximum luminance level of the backlight module. In some examples, the single side driving inverter can be configured to alternate the operating currents between a higher level and a lower level such that the lamps alternate between a brighter state and a darker state for an entire range of user-selectable luminance levels of the backlight module. The driver can be configured to control the operating current to be at a level such that more than 80% of the current provided to the one end of the lamp flows in the lamp to another end of the lamp. The backlight module can be used in a liquid crystal display television.

In another aspect, in general, an apparatus includes a backlight module for a flat panel display. The backlight module includes a fluorescent lamp having a current-luminance characteristic such that when a current lower than a saturation level is provided to the lamp, the luminance of the lamp increases as the current increases, and the lamp luminance saturates when the current is equal to or higher than the saturation level. The backlight module includes a driver configured to drive the lamp for at least a portion of the time using a current that is higher than 80% of the saturation level.

Implementations of the apparatus may include one or more of the following features. The driver can be configured to drive the lamp using a current that alternates between a higher level and a lower level so that the lamp alternates between a brighter state and a darker state, the current being higher than 80% of the saturation level in the higher level and less than 80% of the saturation level in the lower level. In some examples, the driver can adjust the ratio of the durations of the higher and lower levels to adjust the luminance of the backlight module. In some examples, the driver can adjust the current level in the higher level and/or the lower level to adjust the luminance of the backlight module. The driver can include a single-side-driving inverter that is coupled to a first end of the lamp and provides the current to the lamp, a second end of the lamp being electrically coupled to a ground voltage. The saturation level can be between 5 to 20 mA. The lamp can have a voltage-current characteristic such that the current flowing in the lamp decreases as a voltage applied to the lamp increases when the current is lower than the saturation level.

In another aspect, in general, an apparatus includes a backlight module having a user-selectable maximum luminance, the backlight module including one or more fluorescent lamps having current-luminance characteristics such that the backlight module has a luminance higher than the user-selectable maximum luminance when a continuous current higher than 80% of a saturation level is provided to each lamp. The saturation level is defined such that when a current lower than the saturation level is provided to the lamp, the luminance of the lamp increases as the current increases, and the lamp luminance saturates when the current is equal to or higher than the saturation level. The backlight module includes a driver that is configured to drive each of the one or more lamps using a current that alternates between a higher level and a lower level such that the lamp alternates between a brighter state and a darker state to cause the backlight module to have the user-selectable maximum luminance, the current being higher than 80% of the saturation level during the higher level and less than 80% of the saturation level during the lower level.

Implementations of the apparatus may include one or more of the following features. The driver can include a single-side-driving inverter that is coupled to a first end of each lamp and provides the current to the lamp, a second end of the lamp being electrically coupled to a ground voltage.

In another aspect, in general, a flat panel display having a diagonal size larger than 37 inches includes a fluorescent lamp having a first end and a second end for providing light that is modulated by a plurality of pixel circuits of the display, and a single side driving inverter configured to drive the lamp by providing an AC voltage and an AC current to the first end of the lamp, the single side driving inverter configured to control the AC voltage and the AC current to have levels such that more than 80% of the AC current provided to the first end flows in the lamp to the second end.

Implementations of the method may include one or more of the following features. The single side driving inverter is configured to control the AC voltage and the AC current such that less than 20% of the AC current provided to the first end of the lamp forms leakage currents that flow to ground through stray capacitances. The lamp can be a cold cathode fluorescent lamp. The single side driving inverter is configured to control the AC current to have a root-mean-square (rms) value higher than 80% of a saturation level for at least a portion of the time. The lamp can have a luminance-current characteristic such that when an AC current having an rms value lower than the saturation level is provided to the lamp, the luminance of the lamp increases as the AC current increases, and the lamp luminance saturates when the AC current is equal to or higher than the saturation level.

In another aspect, in general, a method includes driving a fluorescent lamp of a backlight module of a flat panel display by providing to the lamp a current higher than 80% of a saturation level of the lamp for at least a portion of the time. The lamp has a luminance-current characteristic such that when a current lower than the saturation level is provided to the lamp, the luminance of the lamp increases as the current increases, and the lamp luminance saturates when the current is equal to or higher than the saturation level.

Implementations of the method may include one or more of the following features. The lamp can be driven using a single side driving inverter. Providing the current to the lamp can include providing an AC current that alternates between a first level higher than 80% of the saturation level and a second level lower than 80% of the saturation level to cause the lamp to alternate between a brighter level and a darker level. In some examples, the method can include adjusting the ratio of the durations of the first and second levels to adjust the luminance of the backlight module. In some examples, the method can include adjusting the current level provided to the lamp to adjust the luminance of the backlight module. Driving the lamp can include driving the lamp in a negative resistance region in which increasing the voltage across the lamp results in a reduction of the current flowing in the lamp. The method can include modulating the light from the backlight module using pixel circuits to form an image.

In another aspect, in general, a method includes driving a fluorescent lamp of a backlight module of a flat panel display having a diagonal size larger than 37 inches using single side driving by providing an AC voltage and an AC current to a first end of the lamp, the AC voltage and the AC current being selected such that more than 80% of the AC current provided to the first end flows in the lamp to a second end of the lamp.

Implementations of the method may include one or more of the following features. The AC current can be higher than 80% of a saturation level for at least a portion of the time. The lamp can have a luminance-current characteristic such that when an AC current lower than the saturation level is provided to the lamp, the luminance of the lamp increases as the AC current increases, and the lamp luminance saturates when the AC current is equal to or higher than the saturation level. Providing the AC current to the lamp can include providing an AC current that alternates between a first level and a second level so that the lamp alternates between a brighter state and a darker state, the first level being higher than 80% of the saturation level, the second level being lower than 80% of the saturation level. The method can include adjusting the ratio of the durations of the first and second levels to adjust the luminance of the backlight module.

Advantages of the apparatuses and methods may include one or more of the following. By driving the lamp using a higher current closer to the saturation current, the voltage for driving the lamp can be reduced, the leakage current can be reduced, the luminance uniformity of the lamp from one end to the other end can be increased, and the overall luminance uniformity of the display can be enhanced. This is particularly useful for large size displays in which the lengths of the lamps are long. Also, by reducing leakage current, operating the backlight module requires less energy. For mobile devices that use battery to power the backlight module, this results in longer battery life. By driving the lamp using a lamp current close to the saturation current level so that the lamp outputs are near saturation luminance, differences in the luminance of different lamps can be reduced, increasing uniformity of luminance across the display. By operating the lamps so that luminance is more uniform throughout the lengths of the lamps, a single side driving scheme can be used instead of a double side driving scheme, reducing the cost of the display.

### DESCRIPTION OF DRAWINGS

FIG. 1 is a schematic diagram of a backlight module of a flat panel display.

FIG. 2 is a graph of a lamp current waveform at a high voltage end of a lamp.

FIG. 3 is a graph of a lamp current waveform at a low voltage end of the lamp.

FIG. 4 is a graph showing the luminance-current characteristics of the lamp.

FIG. 5 is a graph showing the voltage-current characteristics of the lamp.

FIG. 6 is a graph showing the leakage current versus lamp current characteristics of the lamp.

FIG. 7 is a graph showing measured luminance uniformity of the backlight module.

FIG. 8 is a graph showing measured luminance uniformity of a backlight module

### DETAILED DESCRIPTION

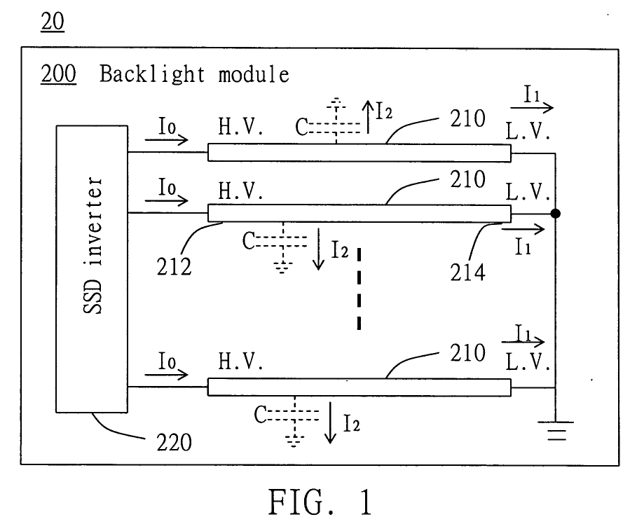

Referring to FIG. 1, a flat panel display 20 can have a more uniform luminance by operating lamps 210 of a backlight module 200 near saturation, as compared to operating the lamps 210 with lower currents. Due to a negative resistance property of the lamps, operating the lamps 210 near saturation allows the operating voltage of the lamps 210 to be reduced, also reducing leakage current, so that luminance of the lamps 210 is more consistent throughout the entire lengths of the lamps 210. By reducing leakage current, power consumption can be reduced, increasing battery life for portable devices.

The flat panel display 20 can be, e.g., a liquid crystal display. The lamps 210 can be, e.g., CCFLs. Each lamp 210 has a high voltage end 212 and a low voltage end 214. The display 20 includes a single side driving (SSD) inverter 220 that converts a DC voltage to an AC voltage (e.g., 100 to 1200V rms). The SSD inverter 220 applies the AC voltage to the high voltage end 212 of each lamp 210, causing an AC current to flow to the high voltage end 212 of the lamp 210. A portion of the current flows through the lamp 210 to generate light. A portion of the current becomes leakage current that is leaked to system ground through stray capacitances C (shown in dashed lines).

Current I0 represents the current measured at the high voltage end 212. Current I1 represents the current measured at the low voltage end 214. Current I2=I1−I0 represents the leakage current.

The SSD inverter 220 includes a controller (not shown) that controls the AC voltages applied to the high voltage end 212 so that the current I0 at the high voltage end 212 has a specified level. In some examples, the voltage and current applied to each lamp 210 can be individually controlled to achieve uniform luminance among different lamps 210. The SSD inverter 220 may control the lamp currents according to user-selected luminance level so that the backlight module 200 shows a desired luminance level.

The flat panel display 20 can be used in, e.g., a television or computer monitor, and can have various sizes. Operating the lamps 210 near saturation is useful for large size displays, such as those having diagonal sizes 37 inches or larger.

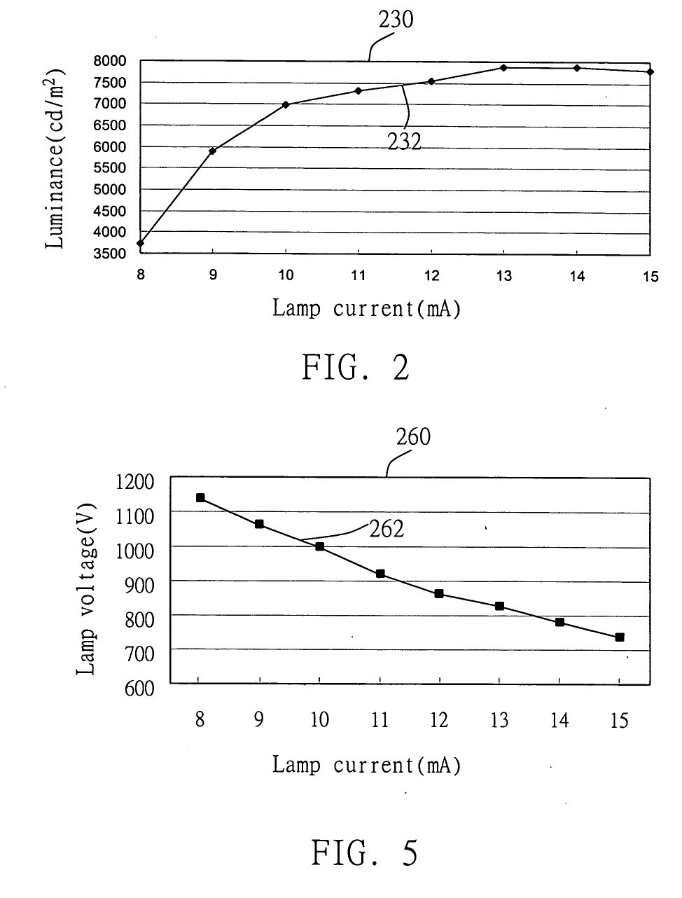

FIG. 2 is a graph 230 showing a curve 232 that represents an average luminance-current characteristic of the lamp 210. The data points for generating the curve 232 were obtained by averaging measurement values obtained from a number of lamps 210 installed in the display 20. The horizontal axis of the graph 230 represents the root-mean-square (rms) value of the AC current I0 measured at the high voltage end 212 of the lamp 210. When the lamp current I0 increases from about 3 mA to about 13 mA, the luminance of the lamp 210 increases in response to the increase in the lamp current 10. For example, when the lamp current I0 increases from 8 mA to 13 mA, the luminance of the lamp 210 increases from 3700 cd/m² to 7900 cd/m².

When the lamp current I0 reaches about 13 mA, the luminance of the lamp 210 “saturates” and does not increase further when the lamp current I0 increases. In this example, the lamp 210 has a saturation luminance level of 7900 cd/m². The operating current I0 of the lamp 210 has a saturation current level of 13 mA. The lamp 210 can be operated near saturation by using the SSD inverter 220 to control the operating current I0 to be about 80% to about 100% of the saturation current. In this example, this corresponds to a range from 10.4 mA to 13 mA. When operating the lamp 210 with a current between about 10.4 ma to about 13 mA, the lamp 210 can have a better optical efficiency in which the percentage of electricity converted to light is higher.

When the operating current I0 of the lamp 210 is at or above the saturation current level, the luminance of the lamp 210 reaches saturation and will not increase further. In some examples, the lamp luminance may decrease when the lamp current I0 increases above the saturation current level.

In some examples, the lamps 210 may have a luminance-current characteristic in which the luminance level asymptotically approach the saturation luminance value as the lamp current I0 increases. In such cases, the saturation current level can be defined as follows. When a lamp current I0 lower than the saturation level is provided to the lamp 210, the luminance of the lamp 210 increases as the current I0 increases. The lamp luminance saturates when the lamp current I0 is equal to or higher than the saturation level such that the lamp luminance does not increase more than 5% when the lamp current I0 increases from the saturation level to a level higher than the saturation level.

The achieve better optical efficiency for the lamps 210, the SSD inverter 220 controls the operating current I0 to be in the range from 80% to 100% of the saturation current level. For example, if the saturation current level of the lamp 210 is 13 mA, the SSD inverter 220 controls the operating current I0 to range from 10.4 mA to 13 mA. The saturation current level is determined manually for each type of lamp. Once the type of lamp 210 for the display 20 is determined, the saturation current level is measured, and the SSD inverter 220 is configured to control the operating current I0 to be within 80% to 100% of the saturation current level. This allows the backlight module 200 to operate with better optical efficiency.

For example, lamps having different lengths and tube diameters may have different saturation current levels. The saturation current levels are also affected by, e.g., the configuration of the display 20, such as how close the lamps 210 are positioned with respect to ground plates, conducting wires, and reflection foils.

An advantage of using a lamp current 10 having an rms value about 80% to 100% of the saturation current level is that the luminance of different lamps 210 can be substantially the same even if there are slight variations in the operating currents provided to different lamps. Different lamps of the same type often have the same saturation luminance. As shown in graph 230 of FIG. 2, when the lamp current I0 is within 80% to 100% of the saturation current level, the lamp luminance changes only slightly in response to changes in the lamp current.

The backlight module 200 includes several lamps 210. When each of the lamps 210 is provided with an operating current between 80% to 100% of the saturation current level, the total luminance of light generated from all the lamps 210 may be higher than the specified maximum luminance for the backlight module 200. The luminance of the backlight module 200 can be reduced by adjusting a duty cycle of the current provided to the lamp 210.

For example, the SSD inverter 220 can control the AC current I0 so that the lamp 210 alternates between a brighter state and a darker state. The AC current I0 can have a frequency higher than, e.g., 1000 Hz, and the AC current I0 can alternate between higher and lower values at a frequency of, e.g., 200 Hz, so that the lamp 210 alternates between the brighter and darker states at 200 Hz. When the lamp 210 is in the brighter state, the AC current I0 can have an rms value higher than 80% of the saturation current level. When the lamp 210 is in the darker state, the AC current I0 can have an rms value lower than 80% of the saturation current level. The AC current I0 can be, e.g., zero, when the lamp 210 is in the darker state, turning the lamp 210 off.

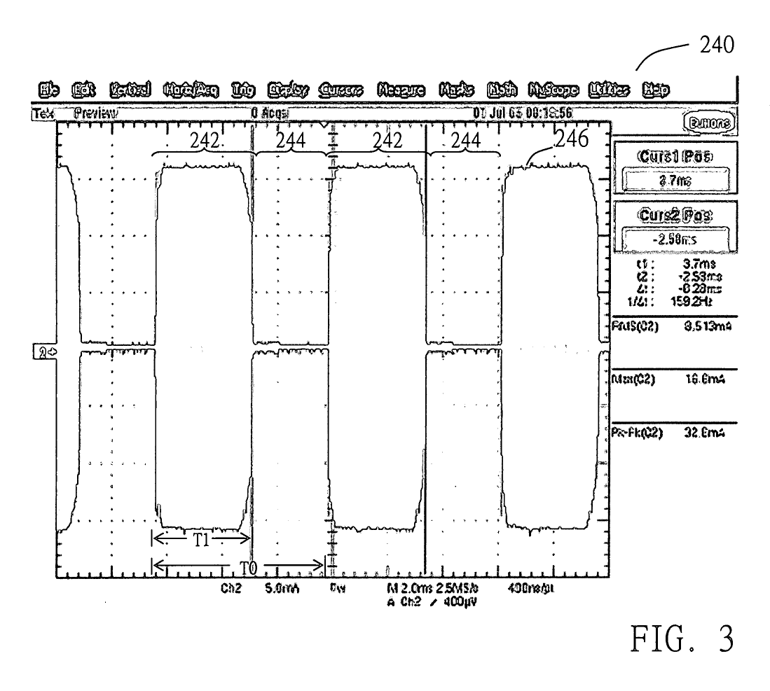

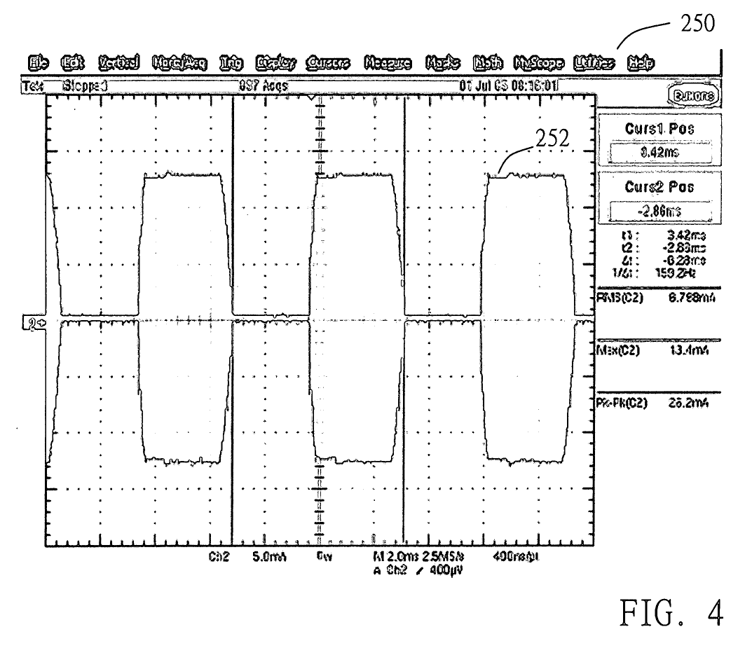

FIG. 3 is a graph 240 of a waveform 246 of the lamp current I0 measured at the high voltage end 212 of the lamp 210. FIG. 4 is a graph 250 of a waveform 252 of the lamp current I1 measured at the low voltage end of the lamp 210. In the example of FIGS. 3 and 4, the SSD inverter 220 provides an AC current I0 that alternates between an “on” state 242 and an “off” state 244. The period T0 represents one cycle of on and off states. The duty cycle is defined as T1/T0, in which T1 is the duration of the on state. The duty cycle is adjusted according to a user-selected luminance level of the display 20.

FIG. 5 is a graph 260 showing a curve 262 representing the voltage-current characteristic of the lamp 210. The curve 262 represents average measurement values obtained from several lamps installed in the display 20. The horizontal axis represents the rms values of the AC current I0 measured at the high voltage end 212 of the lamp 210. The curve 262 shows that the lamp 210 has a negative-resistance characteristic. When the lamp current I0 increases, the voltage across two ends 212, 214 of the lamp 210 decreases. When the lamp current I0 is about equal to the saturation current level, e.g., 13 mA, the lamp 210 shows the saturation luminance, e.g., 7900 cd/m2, and the lamp voltage is about 820 V. By comparison, when the lamp current I0 is about 8 mA, the lamp voltage is higher than 1100 V.

As can be seen from FIG. 5, by operating the lamp 210 using a lamp current I0 equal to about 80% to 100% of the saturation current level, the lamp voltage can be reduced, as compared to using a lamp current I0 that is less than 80% of the saturation current level.

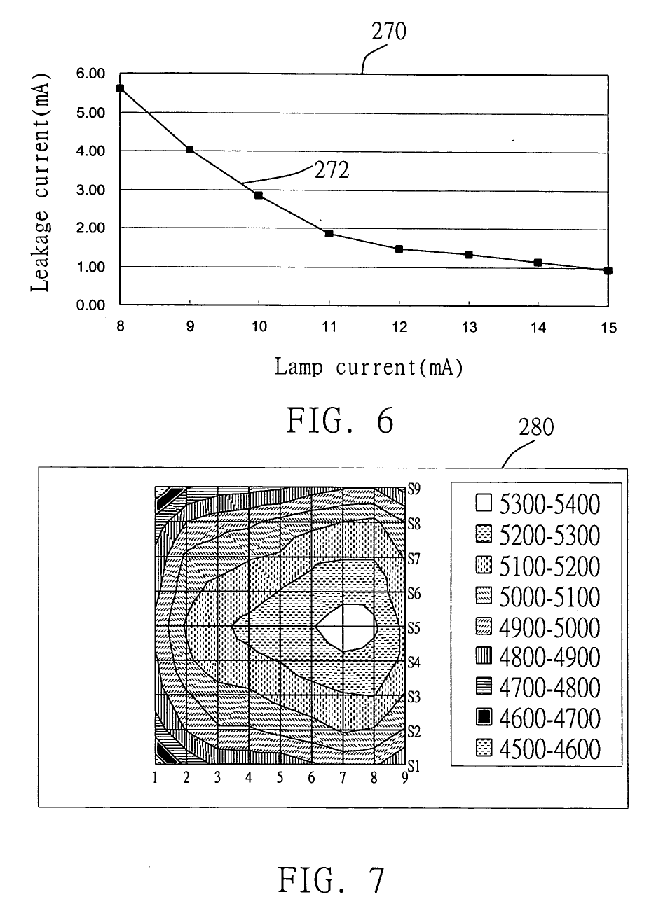

FIG. 6 is a graph 270 showing a curve 272 representing the leakage current I2 versus lamp current I0 characteristic of the lamp 210. The curve 272 represents average measurement values obtained from several lamps installed in the display 20. The horizontal axis represents the rms values of the AC current I0 measured at the high voltage end 212 of the lamp 210. The leakage current 12 is measured while the lamps 210 are mounted in the display 20, representing realistic current leakage conditions.

As show in FIG. 6, the leakage current I2 decreases as the lamp current I0 increases. Driving the lamp 210 using a lamp current I0 that is substantially equal to the saturation current level can result in a smaller leakage current I2 as compared to driving the lamp 210 using a smaller lamp current I0. In the example of FIG. 6, driving the lamp 210 using a lamp current I0 equal to 80% to 100% of the saturation current level (13 mA) results in a leakage current of between 1.3 mA to 2.5 mA, which is less than 20% of the lamp current I0.

The backlight module 200 controls the driving voltage and the driving current to cause the lamp 210 to operate in a low leakage-current region by maintaining the lamp current I0 to be about 80% to 100% of the saturation current level. This can result in a leakage current I2 that is smaller than 20% of the current I0 flowing through the high voltage end 212.

For example, when the operation current I0 outputted from the SSD inverter 220 is 13 mA, the current I0 flowing through the high voltage end 212 is 13 mA, the voltage across the two ends 212, 214 of the lamp 210 is about 820 V, and the leakage current I2 is about 1.3 mA. The leakage current I2 is smaller than 20% of the current I0 (13 mA) flowing through the high voltage end 212.

FIG. 7 is a graph 280 showing measured luminance uniformity of the backlight module 200. The graph 280 was obtained by measuring the luminance values at 81 positions on the backlight module 200 using a BM 5A luminance meter. The measurements show that the luminance of the backlight module 200 ranged from 5300 cd/m² to 4600 cd/m². The operating current I0 of the backlight module 200 was designed to be about 80% to 100% of the saturation current of the lamp 210. When the measurements were taken, the current I0 at the high voltage end 212 was 12.5 mA. This results in a lower lamp voltage, a lower leakage current, and improved luminance uniformity of the backlight module 200, as compared to using an operating current I0 less than 80% of the saturation current.

Based on the data shown in FIG. 7, it can be determined that the backlight module 200 has a luminance uniformity about 84.6%, which is comparable to the uniformity that can be obtained by using double side driving. The luminance uniformity is determined by dividing the luminance of the darkest point by the luminance of the brightest point.

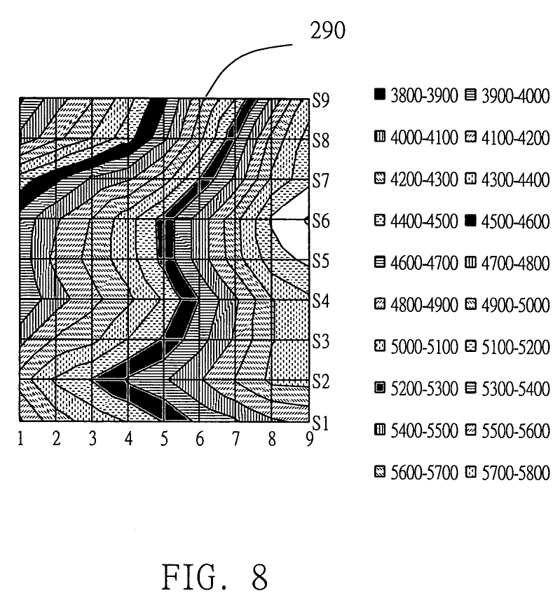

FIG. 8 is a graph 290 showing measured luminance uniformity of a backlight module that uses an SSD inverter to drive the lamps using an operating current I0 of 8 mA for each lamp. Based on the data shown in FIG. 8, it can be determined that the luminance uniformity is about 65%. Graph 290 shows that the luminance of the backlight module decreases from left to right, causing non-uniformity in the display luminance. A comparison of the graphs 280 (FIG. 7) and 290 shows that when a single side driving inverter 220 is used, driving the CCFLs using a current equal about 80% to 100% of the saturation current results in better luminance uniformity.

Although some examples have been discussed above, other implementations and applications are also within the scope of the following claims. For example, the voltage values, current values, and frequency values can be different from those described above. The shapes and dimension of the display 200 can vary, and the number of lamps in the backlight module can vary. For example, the display 200 can have a diagonal size of 15 inches or larger. The display 200 can have a diagonal size of 30 inches or larger. One or more diffusion films can be used to diffuse the light from the lamps 210 to make the light spread more even. Instead of aligning the lamps 210 horizontally in the backlight module 200 as in FIG. 1, the lamps 210 can also be aligned vertically in the backlight module 200.

The lamps 210 can be driven using an operating current that is higher than the saturation current. In some cases, this can further reduce leakage current, resulting in increased luminance uniformity. In examples where the lamps 210 have a luminance level that asymptotically approach the saturation luminance value as the lamp current I0 increases, the saturation current level can be defined such that the lamp luminance does not increase more than 2% (or some other number) when the lamp current I0 increases from the saturation level to a level higher than the saturation level. The lamp current is controlled to be about 80% to about 100% of the saturation level.

What is claimed is:

1. A backlight module, comprising:
a lamp; and
a single side driving inverter that is coupled to one end of the lamp and configured to control an operating current of the lamp to be within 80% to 100% of a saturation luminance current,
wherein the lamp has a characteristic such that when the operating current is lower than the saturation luminance current, the lamp luminance increases as the operating current increases, and when the operating current is substantially equal to or higher than the saturation luminance current, the lamp luminance does not increase as the operating current increases.

2. The backlight module of claim 1, wherein the lamp comprises cold cathode fluorescent lamp.

3. The backlight module of claim 1, wherein the single side driving inverter is configured to adjust a duty cycle of the operating current to reduce the luminance of the lamp.

4. The backlight module of claim 1, further comprising additional lamps, the single side driving inverter configured to control operating currents of each of the additional lamps to be within 80% to 100% of the saturation luminance current, wherein the single side driving inverter is configured to alternate the operating currents between a higher level and a lower level such that the lamps alternate between a brighter state and a darker state for a user-selectable maximum luminance level of the backlight module.

5. The backlight module of claim 4 wherein the single side driving inverter is configured to alternate the operating currents between a higher level and a lower level such that the lamps alternate between a brighter state and a darker state for an entire range of user-selectable luminance levels of the backlight module.

6. The backlight module of claim 1 wherein the driver is configured to control the operating current to be at a level such that more than 80% of the current provided to the one end of the lamp flows in the lamp to another end of the lamp.

7. A liquid crystal display television comprising the backlight module of claim 1.

8. An apparatus comprising:
a backlight module for a flat panel display, the backlight module comprising:
a fluorescent lamp having a current-luminance characteristic such that when a current lower than a saturation level is provided to the lamp, the luminance of the lamp increases as the current increases, and the lamp luminance saturates when the current is equal to or higher than the saturation level; and
a driver configured to drive the lamp for at least a portion of the time using a current that is higher than 80% of the saturation level.

9. The apparatus of claim 8 wherein the driver is configured to drive the lamp using a current that alternates between a higher level and a lower level so that the lamp alternates between a brighter state and a darker state, the current being higher than 80% of the saturation level in the higher level and less than 80% of the saturation level in the lower level.

10. The apparatus of claim 9 wherein the driver adjusts the ratio of the durations of the higher and lower levels to adjust the luminance of the backlight module.

11. The apparatus of claim 9 wherein the driver adjusts the current level in the higher level and/or the lower level to adjust the luminance of the backlight module.

12. The apparatus of claim 8 wherein the driver comprises a single-side-driving inverter that is coupled to a first end of the lamp and provides the current to the lamp, a second end of the lamp being electrically coupled to a ground voltage.

13. The apparatus of claim 8 wherein the saturation level is between 5 to 20 mA.

14. The apparatus of claim 8 wherein the lamp has a voltage-current characteristic such that the current flowing in the lamp decreases as a voltage applied to the lamp increases when the current is lower than the saturation level.

15. An apparatus comprising:
a backlight module having a user-selectable maximum luminance, the backlight module comprising:
one or more fluorescent lamps having current-luminance characteristics such that the backlight module has a luminance higher than the user-selectable maximum luminance when a continuous current higher than 80% of a saturation level is provided to each lamp,
the saturation level being defined such that when a current lower than the saturation level is provided to the lamp, the luminance of the lamp increases as the current increases, and the lamp luminance saturates when the current is equal to or higher than the saturation level; and
a driver configured to drive each of the one or more lamps using a current that alternates between a higher level and a lower level such that the lamp alternates between a brighter state and a darker state to cause the backlight module to have the user-selectable maximum luminance, the current being higher than 80% of the saturation level during the higher level and less than 80% of the saturation level during the lower level.

16. The apparatus of claim 15 wherein the driver comprises a single-side-driving inverter that is coupled to a first end of each lamp and provides the current to the lamp, a second end of the lamp being electrically coupled to a ground voltage.

17. A flat panel display having a diagonal size larger than 37 inches, comprising:
a fluorescent lamp having a first end and a second end for providing light that is modulated by a plurality of pixel circuits of the display; and
a single side driving inverter configured to drive the lamp by providing an AC voltage and an AC current to the first end of the lamp, the single side driving inverter configured to control the AC voltage and the AC current to have levels such that more than 80% of the AC current provided to the first end flows in the lamp to the second end.

18. The flat panel display of claim 17 wherein the single side driving inverter is configured to control the AC voltage and the AC current such that less than 20% of the AC current provided to the first end of the lamp forms leakage currents that flow to ground through stray capacitances.

19. The flat panel display of claim 17 wherein the lamp comprises a cold cathode fluorescent lamp.

20. The flat panel display of claim 17 wherein the single side driving inverter is configured to control the AC current to have a root-mean-square (rms) value higher than 80% of a saturation level for at least a portion of the time,
the lamp having a luminance-current characteristic such that when an AC current having an rms value lower than the saturation level is provided to the lamp, the luminance of the lamp increases as the AC current increases, and the lamp luminance saturates when the AC current is equal to or higher than the saturation level.

21. A method comprising:
driving a fluorescent lamp of a backlight module of a flat panel display by providing to the lamp a current higher than 80% of a saturation level of the lamp for at least a portion of the time,
the lamp having a luminance-current characteristic such that when a current lower than the saturation level is provided to the lamp, the luminance of the lamp increases as the current increases, and the lamp luminance saturates when the current is equal to or higher than the saturation level.

22. The method of claim 21 wherein driving the lamp comprises using a single side driving inverter to drive the lamp.

23. The method of claim 21 wherein providing the current to the lamp comprises providing an AC current that alternates between a first level higher than 80% of the saturation level and a second level lower than 80% of the saturation level to cause the lamp to alternate between a brighter level and a darker level.

24. The method of claim 23, further comprising adjusting the ratio of the durations of the first and second levels to adjust the luminance of the backlight module.

25. The method of claim 21, further comprising adjusting the current level provided to the lamp to adjust the luminance of the backlight module.

26. The method of claim 21 wherein driving the lamp comprises driving the lamp in a negative resistance region in which increasing the voltage across the lamp results in a reduction of the current flowing in the lamp.

27. The method of claim 21, further comprising modulating the light from the backlight module using pixel circuits to form an image.

28. A method comprising:
driving a fluorescent lamp of a backlight module of a flat panel display having a diagonal size larger than 37 inches using single side driving by providing an AC voltage and an AC current to a first end of the lamp, the AC voltage and the AC current being selected such that more than 80% of the AC current provided to the first end flows in the lamp to a second end of the lamp.

29. The method of claim 28 wherein the AC current is higher than 80% of a saturation level for at least a portion of the time,
the lamp having a luminance-current characteristic such that when an AC current lower than the saturation level is provided to the lamp, the luminance of the lamp increases as the AC current increases, and the lamp luminance saturates when the AC current is equal to or higher than the saturation level.

30. The method of claim 28 wherein providing the AC current to the lamp comprises providing an AC current that alternates between a first level and a second level so that the lamp alternates between a brighter state and a darker state, the first level being higher than 80% of the saturation level, the second level being lower than 80% of the saturation level.

31. The method of claim 30, further comprising adjusting the ratio of the durations of the first and second levels to adjust the luminance of the backlight module.
